(19) United States
(12) Patent Application Publication
(10) Pub. No.: US 2016/0011890 A1
(43) Pub. Date: Jan. 14, 2016

(54) COMPATIBILITY METHOD AND APPARATUS

(71) Applicant: Huawei Technologies Co., Ltd., Shenzhen (CN)

(72) Inventor: Chongkang Tan, Beijing (CN)

(21) Appl. No.: 14/858,593

(22) Filed: Sep. 18, 2015

Related U.S. Application Data
(63) Continuation of application No. PCT/CN2014/070961, filed on Jan. 21, 2014.

(30) Foreign Application Priority Data
Mar. 19, 2013 (CN) 201310088109.0

(51) Int. Cl. G06F 9/455; G06F 9/445

(52) U.S. Cl. CPC G06F 9/45516; G06F 9/445

(57) ABSTRACT

Embodiments of the present invention provide a compatibility method and apparatus, which relate to the computer field, can support ABI compatibility of multiple operating systems and an existing ABI compatibility technology, and facilitate further extension of multiple ABI compatibility technologies. The compatibility method includes: if a first target program is a locally registered target program, creating a first process for the first target program; remapping the first target program to generate a remapping table, where the remapping table indicates a correspondence between the first target program and the remapped first target program; loading the remapped first target program into a local memory corresponding to the first process, so as to generate an image of the remapped first target program; reconstructing the image; and determining a redirection interface of the reconstructed image, so as to execute the first process.

### CROSS-REFERENCE TO RELATED APPLICATIONS

This application is a continuation of International Application No. PCT/CN2014/070961, filed on Jan. 21, 2014, which claims priority to Chinese Patent Application No. 201310088109.0, filed on Mar. 19, 2013, both of which are hereby incorporated by reference in their entireties.

### TECHNICAL FIELD

The present invention relates to the computer field, and in particular, to a compatibility method and apparatus.

### BACKGROUND

In a data center operating system, a most direct way to solve mass remaining application program problems is to use an ABI (Application Binary Interface, application binary interface) compatibility technology. The ABI compatibility technology refers to simulating, in a host operating system, a binary environment in which a target program can be executed. When the ABI compatibility technology is used, the target program can be executed in the corresponding host operating system without being modified.

The ABI compatibility technology used at present mainly includes a system level ABI compatibility technology and a process level ABI compatibility technology. The system level ABI compatibility technology refers to simulating, in a host operating system, by means of a virtual machine, a virtual environment in which a target program can be executed. The process level ABI compatibility technology refers to simulating, in a host operating system, by means of a dynamic link, a virtual environment in which a target program can be executed.

The ABI compatibility technology in the prior art is to add, in a host operating system, according to an operating system of a target program, a corresponding binary environment in which the target program can be executed, so that the target program can be executed in the binary environment that is simulated in the host operating system, to implement compatibility of the target program in the host operating system.

However, currently, compatibility technologies of different operating systems are relatively independent; therefore, the foregoing ABI compatibility technology can only implement ABI compatibility of an operating system, but cannot implement ABI compatibility of multiple different operating systems.

### SUMMARY

Embodiments of the present invention provide a compatibility method and apparatus, which can support ABI compatibility of multiple operating systems, support an existing ABI compatibility technology, and facilitate further extension of multiple ABI compatibility technologies.

To achieve the foregoing objective, the following technical solutions are adopted in the embodiments of the present invention:

According to a first aspect, an embodiment of the present invention provides a compatibility method, including:

if a first target program is a locally registered target program, creating a first process for the first target program;

remapping the first target program;

generating a remapping table, where the remapping table indicates a correspondence between the first target program and the remapped first target program;

loading, according to the remapping table, the remapped first target program into a local memory corresponding to the first process, so as to generate an image of the remapped first target program;

reconstructing the image; and

determining a redirection interface of the reconstructed image, so as to execute the first process.

In a first possible implementation manner of the first aspect, the remapping the first target program specifically includes:

performing segment reassembly and/or offset calculation on the first target program.

With reference to the foregoing first aspect or the first possible implementation manner of the first aspect, in a second possible implementation manner, the loading, according to the remapping table, the remapped first target program into a local memory corresponding to the first process, so as to generate an image of the remapped first target program specifically includes:

acquiring a symbol table and a relocation table that are included in the first target program; and

loading the remapped first target program into the local memory according to the remapping table, and relocating the remapped first target program according to the symbol table and the relocation table, so as to generate the image.

With reference to the foregoing first aspect or any implementation manner of the first possible implementation manner to the second possible implementation manner of the first aspect, in a third possible implementation manner, the reconstructing the image includes:

performing image sharing reconstruction and/or binary translation reconstruction on the image.

With reference to the foregoing first aspect or any implementation manner of the first possible implementation manner to the third possible implementation manner of the first aspect, in a fourth possible implementation manner, the determining a redirection interface of the reconstructed image specifically includes:

determining a redirection target of the reconstructed image, where the redirection target is a local interface corresponding to the reconstructed image; and

executing the redirection target, so as to determine the redirection interface of the reconstructed image.

With reference to the foregoing first aspect or any implementation manner of the first possible implementation manner to the fourth possible implementation manner of the first aspect, in a fifth possible implementation manner, in the procedure of executing the first process, if the image is missing, the remapped first target program is reloaded into the local memory according to the remapping table, so as to generate the image.

According to a second aspect, an embodiment of the present invention provides a compatibility device, including:

a creating unit, configured to: if a first target program is a locally registered target program, create a first process for the first target program;

a mapping unit, configured to remap the first target program;

a generating unit, configured to generate a remapping table, where the remapping table indicates a correspondence between the first target program and the remapped first target program;

a loading unit, configured to load, according to the remapping table, the remapped first target program into a local memory corresponding to the first process, so as to generate an image of the remapped first target program; and

a processing unit, configured to reconstruct the image; where

the processing unit is further configured to determine a redirection interface of the reconstructed image, so as to execute the first process.

In a first possible implementation manner of the second aspect, where

the mapping unit is specifically configured to perform segment reassembly and/or offset calculation on the first target program.

With reference to the second aspect or the first possible implementation manner of the second aspect, in a second possible implementation manner,

the processing unit is specifically configured to acquire a symbol table and a relocation table that are included in the first target program; and

the loading unit is specifically configured to load the remapped first target program into the local memory according to the remapping table, and relocate the remapped first target program according to the symbol table and the relocation table, so as to generate the image.

With reference to the foregoing second aspect or any implementation manner of the first possible implementation manner to the second possible implementation manner of the second aspect, in a third possible implementation manner,

the processing unit is configured to perform image sharing reconstruction and/or binary translation reconstruction on the image.

With reference to the foregoing second aspect or any implementation manner of the first possible implementation manner to the third possible implementation manner of the second aspect, in a fourth possible implementation manner,

the processing unit is specifically configured to determine a redirection target of the reconstructed image and execute the redirection target, so as to determine the redirection interface of the reconstructed image, where the redirection target is a local interface corresponding to the reconstructed image.

With reference to the foregoing second aspect or any implementation manner of the first possible implementation manner to the fourth possible implementation manner of the second aspect, in a fifth possible implementation manner,

the loading unit is further configured to: in the procedure in which the processing unit executes the first process, if the image is missing, reload the remapped first target program into the local memory according to the remapping table, so as to generate the image.

According to the compatibility method and apparatus provided in the embodiments of the present invention, if a first target program is a locally registered target program, a first process is created for the first target program, and the first target program is remapped to generate a remapping table, where the remapping table indicates a correspondence between the first target program and the remapped first target program; then, according to the remapping table, the remapped first target program is loaded into a local memory corresponding to the first process, so as to generate an image of the remapped first target program; the image is reconstructed; and a redirection interface of the reconstructed image is determined, so as to execute the first process. According to this solution, if a first target program of a third-party operating system needs to be executed in an operating system of a host computer and the first target program is a target program that has registered with the operating system of the host computer, the foregoing compatibility method can be used to support compatibility of the first target program in the operating system of the host computer, also can support ABI compatibility of multiple operating systems and an existing ABI compatibility technology, and facilitate further extension of multiple ABI compatibility technologies.

### BRIEF DESCRIPTION OF THE DRAWINGS

To describe the technical solutions in the embodiments of the present invention more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a first flowchart of a compatibility method according to an embodiment of the present invention;

FIG. 2 is a second flowchart of a compatibility method according to an embodiment of the present invention;

FIG. 3 is a first schematic structural diagram of a compatibility device according to an embodiment of the present invention;

FIG. 4 is a second schematic structural diagram of a compatibility device according to an embodiment of the present invention;

FIG. 5 is a schematic diagram of an architecture of an ABI compatible interface according to an embodiment of the present invention; and

FIG. 6 is a schematic diagram of an architecture of an ABI compatible state machine according to an embodiment of the present invention.

### DETAILED DESCRIPTION

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

### Embodiment 1

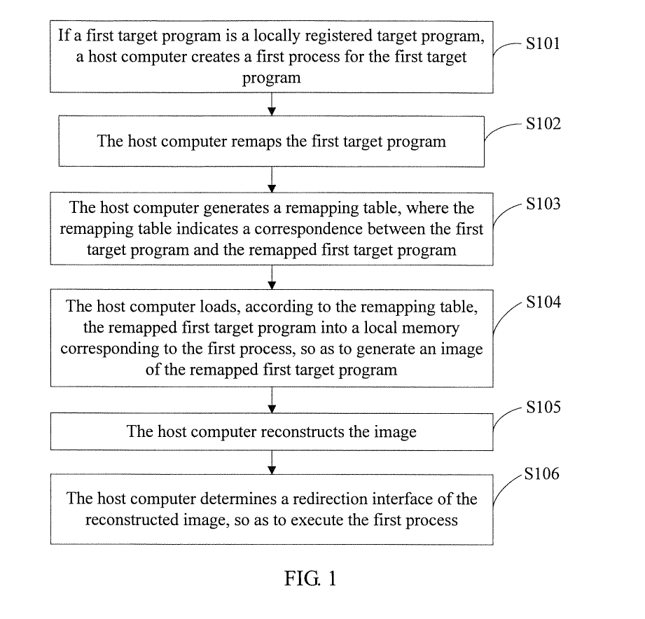

As shown in FIG. 1, an embodiment of the present invention provides a compatibility method, including:

S101. If a first target program is a locally registered target program, a host computer creates a first process for the first target program.

The first target program is a target program in a third-party operating system that is different from an operating system installed in the host computer. The operating system of the host computer and the third-party operating system are different operating systems; therefore, to enable the first target program to be executed in the operating system of the host computer, compatibility of the operating system of the host computer with the first target program needs to be implemented.

Exemplarily, to implement compatibility of the first target program in the operating system of the host computer, the host computer first needs to determine whether the first target program is a locally (that is, the operating system of the host computer) registered target program. If the first target program is a target program that has registered with the operating system of the host computer, the host computer creates the first process for the first target program.

Particularly, a “process” is the basis of an operating system structure, is a program that is being executed, is a program instance that is running in a computer, is an entity that may be allocated to a processor and executed by the processor.

It should be noted that the compatibility method provided in this embodiment of the present invention may be an ABI compatibility method. In this method, only a target program that registers with the operating system of the host computer can implement compatibility in the operating system of the host computer, that is, a third-party operating system, only an ABI compatibility component of which can be successfully registered with the operating system of the host computer, can implement compatibility with the operating system of the host computer.

S102. The host computer remaps the first target program.

After the host computer creates the first process for the first target program, the host computer remaps the first target program. How the host computer remaps the first target program is described in detail in a subsequent embodiment.

A person of ordinary skill in the art can understand that, because an organizational structure of a target program in the operating system of the host computer may be different from an organizational structure of a target program in the third-party operating system, the host computer maps the target program of the third-party operating system to the target program in the operating system of the host computer so that the organizational structure of the target program of the third-party operating system is the same as the organizational structure of the target program in the operating system of the host computer.

S103. The host computer generates a remapping table, where the remapping table indicates a correspondence between the first target program and the remapped first target program.

In the procedure in which the host computer is remapping the first target program, the host computer is generating the remapping table while remapping the first target program, that is, a result of the remapping performed by the host computer for the first target program is as follows: an organizational structure of the first target program is the same as an organizational structure of the target program in the operating system of the host computer, and the host computer generates the remapping table corresponding to the remapping procedure, where the remapping table indicates the correspondence between the first target program and the remapped first target program.

S104. The host computer loads, according to the remapping table, the remapped first target program into a local memory corresponding to the first process, so as to generate an image of the remapped first target program.

The host computer loads, according to the remapping table, the remapped first target program into the local memory corresponding to the first process, that is, a memory in the host computer, so as to generate the image of the remapped first target program.

It should be noted that in the computer field, a target program is a binary document stored in a hard disk, and the target program that is loaded from the hard disk into the local memory is referred to as an image.

Further, for the compatibility method provided in this embodiment of the present invention, the first process created in S101 is a management structure of a process, that is, the created first process is a program architecture. The first process is a program instance that runs in the memory of the host computer, only after S104 of loading the remapped first target program into the memory of the host computer corresponding to the first process.

S105. The host computer reconstructs the image.

After remapping (that is, preprocessing) the first target program, the host computer further needs to perform further processing on the first target program that is loaded into the local memory corresponding to the first process, that is, performs further processing on the image of the first target program. That is, the host computer needs to reconstruct the image of the first target program.

The procedure in which the host computer reconstructs the image of the first target program, is to improve quality and performance of the first target program by adjusting program code of the first target program on the basis of not changing an implementation function of the first target program, so that a design pattern and architecture of the first target program is more appropriate, thereby improving extensibility and maintainability of the first target program.

S106. The host computer determines a redirection interface of the reconstructed image, so as to execute the first process.

After reconstructing the image of the first target program, the host computer starts to execute the first process. In the procedure of executing the first process, if a redirection operation is required, the host computer determines the redirection interface of the reconstructed image, so as to continue to execute the first process.

A person of ordinary skill in the art can understand that “redirection” is to re-determine a direction for various requests of a network or a system by using various methods and to switch to a location indicated by the direction. In this embodiment of the present invention, in the procedure in which the host computer executes the first process, if the redirection operation is required, the host computer enters a redirection interface undetermined state. Then, the host computer locally (that is, the operating system of the host computer) determines an interface corresponding to the image of the first target program and switches to execute the interface. Then, the host computer enters a redirection interface determined state, that is, the host computer has determined the redirection interface of the reconstructed image, so as to continue to execute the first process.

Certainly, after the host computer executes the interface, the host computer returns to a position of the redirection operation in the first process to continue to execute the first process.

Exemplarily, in the procedure in which the host computer executes the first process, if reaching a position where there is a function call in the image of the first target program, the host computer determines, in the system of the host computer, a function that has the same functionality as that of a called function in the image of the first target program, and switches to execute the function, and after the host computer finishes execution of the function, the host computer returns to an address after the function call, so as to continue to execute the first process.

According to the compatibility method provided in this embodiment of the present invention, if a first target program is a locally registered target program, a first process is created for the first target program, and the first target program is remapped to generate a remapping table, where the remapping table indicates a correspondence between the first target program and the remapped first target program; then, according to the remapping table, the remapped first target program is loaded into a local memory corresponding to the first process, so as to generate an image of the remapped first target program; the image is reconstructed; and a redirection interface of the reconstructed image is determined, so as to execute the first process. According to this solution, if a first target program of a third-party operating system needs to be executed in an operating system of a host computer, and the first target program is a target program that has registered with the operating system of the host computer, the foregoing compatibility method can be used to support the first target program for compatibility in the operating system of the host computer, also can support ABI compatibility of multiple operating systems and an existing ABI compatibility technology, and facilitate further extension of multiple ABI compatibility technologies.

### Embodiment 2

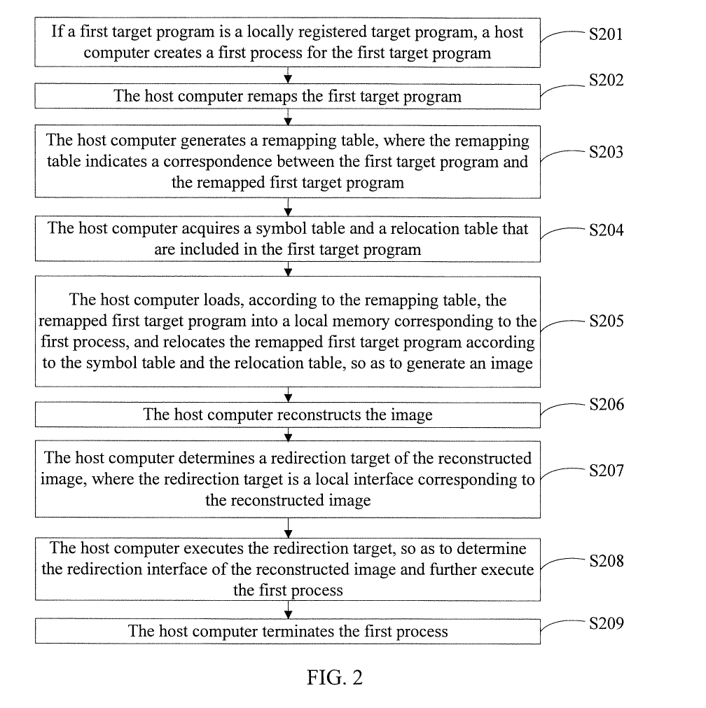

As shown in FIG. 2, an embodiment of the present invention further provides a compatibility method, including:

S201. If a first target program is a locally registered target program, a host computer creates a first process for the first target program.

The first target program is a target program in a third-party operating system that is different from an operating system installed in the host computer. The operating system of the host computer and the third-party operating system are different operating systems; therefore, to enable the first target program to be executed in the operating system of the host computer, compatibility of the operating system of the host computer with the first target program needs to be implemented.

Exemplarily, to implement compatibility of the first target program in the operating system of the host computer, the host computer first needs to determine whether the first target program is a locally (that is, the operating system of the host computer) registered target program. If the first target program is a target program that has registered with the operating system of the host computer, the host computer creates the first process for the first target program.

It should be noted that the compatibility method provided in this embodiment of the present invention may be an ABI compatibility method. In this method, only a target program that registers with the operating system of the host computer can implement compatibility in the operating system of the host computer, that is, a third-party operating system, only an ABI compatibility component of which can be successfully registered with the operating system of the host computer, can implement compatibility with the operating system of the host computer.

S202. The host computer remaps the first target program.

A person of ordinary skill in the art may understand that, because an organizational structure of a target program in the operating system of the host computer may be different from an organizational structure of a target program in the third-party operating system, the host computer maps the target program in the third-party operating system to the target program in the operating system of the host computer so that the organizational structure of the target program in the third-party operating system is the same as the organizational structure of the target program in the operating system of the host computer.

In this embodiment of the present invention, a method for remapping the first target program by the host computer specifically includes the following:

The host computer performs segment reassembly and/or offset calculation on the first target program. Specifically, an organizational structure of a target program in the operating system of the host computer may be different from an organizational structure of a target program in the third-party operating system; therefore, in the procedure in which the host computer remaps the first target program, storage addresses need to be re-allocated to all program code segments in the first target program, that is, the segment reassembly is performed on all the program code segments in the first target program. The storage addresses of all the program code segments on which the segment reassembly is performed are changed. Therefore, the host computer further needs to calculate offset addresses of all the program code segments on which the segment reassembly is performed, so that the host computer can correctly execute all the program code segments with adjusted storage addresses.

It should be noted that because of differences in operating systems, when remapping the first target program, the host computer may only need to perform the segment reassembly on all the program code segments in the first target program, or may only need to perform the offset calculation on all the program code segments in the first target program, or may need to perform both the segment reassembly and the offset calculation on all the program code segments in the first target program. A specific remapping procedure may be adaptively adjusted according to requirement of different operating systems, which is not limited in the present invention.

S203. The host computer generates a remapping table, where the remapping table indicates a correspondence between the first target program and the remapped first target program.

In the procedure in which the host computer is remapping the first target program, the host computer is generating the remapping table while remapping the first target program, that is, a result of the remapping performed by the host computer for the first target program is as follows: an organizational structure of the first target program is the same as the organizational structure of the target program in the operating system of the host computer, and the host computer generates the remapping table corresponding to the remapping procedure, that is, the remapping table indicates the correspondence between the first target program and the remapped first target program.

S204. The host computer acquires a symbol table and a relocation table that are included in the first target program.

The host computer acquires the corresponding symbol table and the corresponding relocation table from the first target program.

In the computer field, the “symbol table” is a table in which related information, such as a type and a feature of some syntactic symbols in a source program, is constantly collected, recorded and used in a source program compilation procedure. A constant table, a variable name table, an array name table, a procedure name table, a label table and the like, are referred to as the symbol table. In addition, organization, structure and management method of the symbol table can directly affect working efficiency of a compilation system.

Accordingly, the “relocation table” is a table that is generated while a computer is relocating a target program in a target program linking procedure, which is used to indicate a correspondence between a logical address of the target program and a physical address of the target program in a memory of the computer. “Relocation” is to locate an address of a symbol in the target program to a correct location in the target program linking procedure.

It should be noted that the symbol table and the relocation table are respectively generated in the source program compilation procedure and in the target program linking procedure and are included in the first target program.

S205. The host computer loads, according to the remapping table, the remapped first target program into a local memory corresponding to the first process, and relocates the remapped first target program according to the symbol table and the relocation table, so as to generate an image.

The host computer loads, according to the remapping table, the remapped first target program into the local memory corresponding to the first process, that is, a memory in the host computer, and relocates the remapped first target program according to the symbol table and the relocation table, so as to generate the image corresponding to the first target program.

In this embodiment of the present invention, the host computer relocates variables of the first target program according to the symbol table and the relocation table, so as to generate the image that can be executed and is corresponding to the first target program.

A person of ordinary skill in the art can understand that, storage addresses of the variables in the first target program are logical addresses before the relocation, while storage addresses of the variables in the first target program are physical addresses in the memory of the computer after the relocation.

It should be noted that in the computer field, the target program stored in a hard disk is a binary document, and the target program loaded from the hard disk into the local memory is referred to as an image.

Further, a “process” is the basis of an operating system structure, is a program that is being executed, is a program instance that is running in a computer, is an entity that may be allocated to a processor and executed by the processor. For the compatibility method provided in this embodiment of the present invention, the first process created in S201 is a management structure of a process, that is, the created first process is a program architecture of a process. The first process is a program instance that runs in the memory of the host computer, only after S205 of loading the remapped first target program into the memory of the host computer corresponding to the first process.

S206. The host computer reconstructs the image.

After remapping (that is, preprocessing) the first target program, the host computer further needs to perform further processing on the first target program that is loaded into the local memory corresponding to the first process, that is, the host computer reconstructs the image of the first target program.

The procedure in which the host computer reconstructs the image of the first target program, is to improve quality and performance of the first target program by adjusting program code of the first target program on the basis of not changing an implementation function of the first target program, so that a design pattern and architecture of the first target program is more appropriate, thereby improving extensibility and maintainability of the first target program.

In this embodiment of the present invention, when the host computer reconstructs the image of the first target program, two requirements, image sharing and binary translation, need to be considered, that is, the host computer may need to perform image sharing reconstruction and/or binary translation reconstruction on the image of the first target program.

Exemplarily, in an image sharing procedure, a segment of program code or a segment of data that is shared by two or more target programs and is in the memory of the computer, needs to be directed to a fixed location; therefore, when the image sharing is performed on the image of the first target program and an image of another target program, the host computer needs to reconstruct, that is, the image sharing reconstruction on the image of the first target program.

“Binary translation” is a technology of directly translating an executable binary program, so that an binary program of a processor can be translated and executed in another processor, thereby implementing migration of binary programs in different processors easily, and enlarging the applicable scope of hardware/software.

If a third-party operating system and a operating system of the host computer are different instruction systems, the host computer needs to perform the binary translation on the image of the first target program. In the procedure of the binary translation, the host computer needs to perform the reconstruction, that is, the binary translation reconstruction on the image of the first target program, so as to rearrange the image.

It should be noted that, under different requirements, manners in which the host computer reconstructs the image of the first target program are different. The host computer may perform the image sharing reconstruction on the image of the first target program, or may perform the binary translation reconstruction on the image of the first target program, or may perform both the image sharing reconstruction and the binary translation reconstruction on the image of the first target program. A specific reconstruction manner may be adaptively adjusted according to actual requirements of different operating systems, which is not limited in the present invention.

S207. The host computer determines a redirection target of the reconstructed image, where the redirection target is a local interface corresponding to the reconstructed image.

After reconstructing the image of the first target program, the host computer starts to execute the first process. In the procedure of executing the first process, if a redirection operation is required, the host computer determines the redirection target of the reconstructed image, so as to continue to execute the first process.

A person of ordinary skill in the art can understand that “redirection” is to re-determine a direction for various requests of a network or a system by using various methods and to switch to a location indicated by the direction. In this embodiment of the present invention, in the procedure in which the host computer executes the first process, if the redirection operation is required, the host computer enters a redirection interface undetermined state. Then, the host computer locally (that is, in the operating system of the host computer) determines an interface corresponding to the image of the first target program, that is, determines the redirection target.

S208. The host computer executes the redirection target, so as to determine the redirection interface of the reconstructed image and further execute the first process.

After determining the redirection target, the host computer switches to execute the redirection target. Further, the host computer enters a redirection interface determined state, that is, the host computer has determined the redirection interface of the reconstructed image, so as to continue to execute the first process.

Certainly, if the host computer finishes execution of the redirection target, the host computer returns to a position of the redirection operation in the first process to continue to execute the first process.

Exemplarily, in the procedure in which the host computer executes the first process, if reaching a position, where there is a function call, in the image of the first target program, the host computer determines, in the system of the host computer, a function that has the same functionality as that of a called function in the image of the first target program, and switches to execute the function, so that the host computer can continue to execute the first process. After the host computer finishes execution of the function, the host computer returns to an address after the function call, so as to continue to execute the first process.

Further, in the procedure of executing the first process, if the image of the first target program is missing, the host computer reloads the remapped first target program into the first process according to the remapping table, so as to generate the image and further to execute the first process again.

S209. The host computer terminates the first process.

A case in which the host computer terminates the first process is any one of the following:

(1) After the host computer finishes execution of the first process, the host computer terminates the first process.

(2) When the host computer does not successfully load the first process, the host computer terminates the first process.

(3) When the host computer does not successfully determine the redirection interface of the image of the first target program, the host computer terminates the first process.

In the foregoing cases, (1) is a normal termination after the execution of the first process finishes, while (2) and (3) are both abnormal terminations in the procedure of executing the first process.

Particularly, if the first target program in S201 is not a target program that has registered with the operating system of the host computer, that is, the first target program cannot implement compatibility in the operating system of the host computer, the host computer directly terminates a compatibility procedure for the first target program.

It should be noted that, the foregoing S201 to S209 is a complete procedure of implementing compatibility of the first target program of the third-party operating system in the operating system of the host computer. However, for a compatibility instruction and a file format of the first target program, in the procedure of implementing the compatibility of the first target program, all these steps may not necessarily to be performed. In the compatibility method provided in this embodiment of the present invention, the ABI compatibility component that is of the third-party operating system and registers with the operating system of the host computer may perform a mandatory step according to an actual requirement, and for a step that does not need to be performed, an instruction corresponding to the step may be set to empty.

According to the compatibility method provided in this embodiment of the present invention, if a first target program is a locally registered target program, a first process is created for the first target program, and the first target program is remapped to generate a remapping table, where the remapping table indicates a correspondence between the first target program and the remapped first target program; then, according to the remapping table, the remapped first target program is loaded into a local memory corresponding to the first process, so as to generate an image of the remapped first target program; the image is reconstructed; and a redirection interface of the reconstructed image is determined, so as to execute the first process. According to this solution, if a first target program of a third-party operating system needs to be executed in an operating system of a host computer and the first target program is a target program that has registered with the operating system of the host computer, the foregoing compatibility method can be used to support compatibility of the first target program in the operating system of the host computer, also can support ABI compatibility of multiple operating systems and an existing ABI compatibility technology, and facilitate further extension of multiple ABI compatibility technologies.

### Embodiment 3

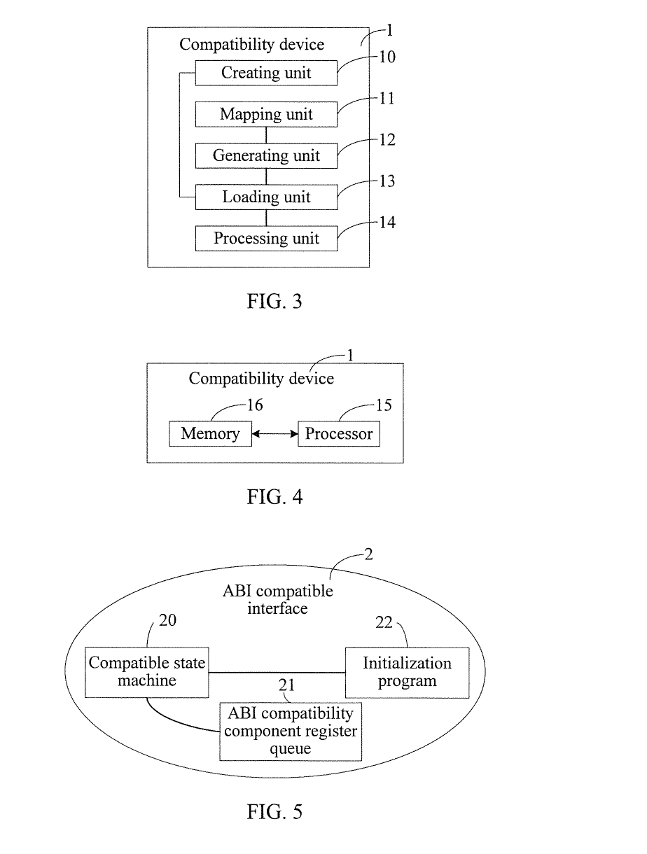

As shown in FIG. 3, an embodiment of the present invention provides a compatibility device 1, including:

a creating unit 10, configured to: if a first target program is a locally registered target program, create a first process for the first target program;

a mapping unit 11, configured to remap the first target program;

a generating unit 12, configured to generate a remapping table, where the remapping table indicates a correspondence between the first target program and the remapped first target program;

a loading unit 13, configured to load, according to the remapping table, the remapped first target program into a local memory corresponding to the first process, so as to generate an image of the remapped first target program; and

a processing unit 14, configured to reconstruct the image.

The processing unit 14 is further configured to determine a redirection interface of the reconstructed image, so as to execute the first process.

Further, the mapping unit 11 is specifically configured to perform segment reassembly and/or offset calculation on the first target program.

Further, the processing unit 14 is specifically configured to acquire a symbol table and a relocation table that are included in the first target program.

The loading unit 13 is specifically configured to load the remapped first target program into the local memory according to the remapping table, and relocate the remapped first target program according to the symbol table and the relocation table, so as to generate the image.

Further, the processing unit 14 is configured to perform image sharing reconstruction and/or binary translation reconstruction on the image.

Further, the processing unit 14 is specifically configured to determine a redirection target of the reconstructed image and execute the redirection target, so as to determine the redirection interface of the reconstructed image, where the redirection target is a local interface corresponding to the reconstructed image.

Further, the loading unit 13 is further configured to: in the procedure of executing the first process by the processing unit 14, if the image is missing, reload the remapped first target program into the local memory according to the remapping table, so as to generate the image.

According to the compatibility device provided in this embodiment of the present invention, if a first target program is a locally registered target program, the compatibility device creates a first process for the first target program and remaps the first target program to generate a remapping table, where the remapping table indicates a correspondence between the first target program and the remapped first target program; then, the compatibility device loads, according to the remapping table, the remapped first target program into a local memory corresponding to the first process, so as to generate an image of the remapped first target program, reconstructs the image, and determines a redirection interface of the reconstructed image, so as to execute the first process. According to this solution, if a first target program of a third-party operating system needs to be executed in an operating system of a host computer and the first target program is a target program that has registered with the operating system of the host computer, a compatibility method provided in an embodiment of the present invention can be performed by using the foregoing compatibility device, so as to support compatibility of the first target program in the operating system of the host computer, and also support ABI compatibility of multiple operating systems and an existing ABI compatibility technology, and facilitate further extension of multiple ABI compatibility technologies.

### Embodiment 4

As shown in FIG. 4, an embodiment of the present invention provides a compatibility device 1, which includes a processor 15 and a memory 16.

The processor 15 is a control and processing center of the compatibility device 1, runs a software program stored in the memory 16, invokes and processes data stored in the memory 16, so as to control the compatibility device to perform a corresponding operation, and implement another function of the compatibility device.

The memory 16 can be configured to store the software program and the data, so that the processor 15 can run the software program stored in the memory 16, to implement the corresponding operation and another function of the compatibility device.

Corresponding to a compatibility method provided in an embodiment of the present invention,

the processor 15 is configured to: if a first target program is a locally registered target program, create a first process for the first target program and store the first process in the memory 16; remap the first target program, generate a remapping table, and store the remapping table in the memory 16, where the remapping table indicates a correspondence between the first target program and the remapped first target program; load, according to the remapping table, the remapped first target program into a local memory corresponding to the first process, so as to generate an image of the remapped first target program; reconstruct the image; and further determine a redirection interface of the reconstructed image, so as to execute the first process.

Further, the processor 15 is specifically configured to perform segment reassembly and/or offset calculation on the first target program.

Further, the processor 15 is specifically configured to acquire a symbol table and a relocation table that are included in the first target program, load, according to the remapping table, the remapped first target program into the local memory corresponding to the first process in the memory 16, and relocate the remapped first target program according to the symbol table and the relocation table, so as to generate the image.

Further, the processor 15 is configured to perform image sharing reconstruction and/or binary translation reconstruction on the image.

Further, the processor 15 is specifically configured to determine a redirection target of the reconstructed image in the memory 16 and execute the redirection target, so as to determine the redirection interface of the reconstructed image, where the redirection target is a local interface corresponding to the reconstructed image.

Further, the processor 15 is further configured to: in the procedure of executing the first process, if the image in the memory 16 is missing, reload, according to the remapping table the remapped first target program into the local memory corresponding to the first process in the memory 16, so as to generate the image.

According to the compatibility device provided in this embodiment of the present invention, if a first target program is a locally registered target program, the compatibility device creates a first process for the first target program and remaps the first target program to generate a remapping table, where the remapping table indicates a correspondence between the first target program and the remapped first target program; then, the compatibility device loads, according to the remapping table, the remapped first target program into a local memory corresponding to the first process, so as to generate an image of the remapped first target program, reconstructs the image, and determines a redirection interface of the reconstructed image, so as to execute the first process. According to this solution, if a first target program of a third-party operating system needs to be executed in an operating system of a host computer and the first target program is a target program that has registered with the operating system of the host computer, a compatibility method provided in an embodiment of the present invention can be performed by using the foregoing compatibility device, so as to support compatibility of the first target program in the operating system of the host computer, and also support ABI compatibility of multiple operating systems and an existing ABI compatibility technology, and facilitate further extension of multiple ABI compatibility technologies.

The following further describes, from the software perspective, an organizational architecture and an implementation manner of a corresponding software program that is executed in a compatibility procedure by the compatibility device 1 provided in this embodiment of the present invention.

As shown in FIG. 5, FIG. 5 is a diagram of an organizational architecture of an ABI compatible interface 2 that is executed in the compatibility procedure by the compatibility device 1 provided in this embodiment of the present invention, where the ABI compatible interface 2 includes a compatible state machine 20, an ABI compatibility component register queue 21 and an initialization program 22.

The compatible state machine 20 defines a set of transform flows (that is, a compatibility procedure) of the first target program in the operating system of the host computer. By using the transform flows, the operating system of the host computer transforms the first target program into the image of the first target program that can be executed in the operating system of the host computer, and executes the image of the first target program in the operating system of the host computer.

The ABI compatibility component register queue 21 is a structure that is configured to register the compatibility component of the third-party operating system. An ABI compatibility component corresponding to each compatible third-party operating system is stored in the ABI compatibility component register queue 21, and the compatibility component is determined by the compatible state machine 20.

The initialization program 22 is responsible for starting the compatible state machine 20, that is, the initialization program 22 first checks whether the first target program is a target program that has registered with the operating system of the host computer. If the first target program is an target program that has registered with the operating system of the host computer, it indicates that the first target program can implement compatibility in the operating system of the host computer. The initialization program 22 starts the compatible state machine 20.

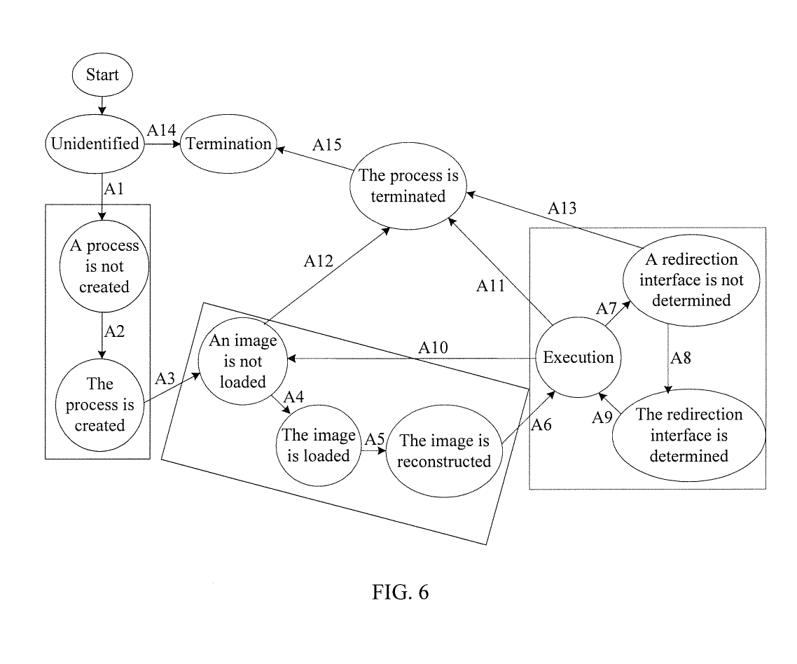

As shown in FIG. 6, FIG. 6 is a schematic diagram of an architecture of the ABI compatible state machine 20 according to this embodiment of the present invention.

The compatible state machine 20 shown in FIG. 6 consists of 12 states, state 1 to state 12, where the 12 states respectively represent each independent step in the ABI compatibility procedure. Switching among the 12 states is corresponding to 15 execution actions, such as A1 to A15. The following describes in detail a workflow of the whole compatible state machine 20, that is, a whole procedure in which the compatible state machine 20 completes the compatibility.

State 1: Unidentified

If a user terminal starts a first target program of a third-party operating system, a operating system of a host computer enters a first target program unidentified state.

A1: Identification of the first target program

The host computer that runs an initialization program traverses target program identification actions of all registered ABI components, so as to identify the first target program.

State 2: The first process is not created.

If the first target program is successfully identified, the operating system of the host computer enters a first process not created state.

A2: Creation of the first process

If the first target program is successfully identified, the host computer creates the first process for the first target program.

State 3: The operating system of the host computer enters a first process created state.

A3: Image preprocessing

The host computer remaps the first target program.

State 4: The image is not loaded.

A4: Image loading

The host computer loads, according to a remapping relationship between the first target program of the third-party operating system and the target program of the operating system of the host computer, the remapped first target program into the memory of the host computer corresponding to the first process. In this procedure, the host computer needs to perform redirection operation on the first target program. The first target program loaded into the memory is called an image.

State 5: The image is loaded.

A5: Image reconstruction

The host computer performs a corresponding reconstruction operation on the remapped image, such as image sharing reconstruction and/or binary translation reconstruction.

State 6: The image is reconstructed.

A6: Execution

The host computer executes the first process.

State 7: Execution.

The operating system of the host computer enters a state of executing the first process.

A7: Detection of the redirection interface

In the procedure of executing the first process, if the redirection operation is required, the operating system of the host computer enters a redirection interface undetermined state.

State 8: The redirection interface is not determined.

A8: Determining of the redirection interface

The host computer determines the redirection target and switches to execute a target program that is in the operating system of the host computer and is corresponding to the first target program of the third-party operating system.

State 9: The redirection interface is determined.

A9: Resumption of the execution

State 10: Execution

The host computer continues to execute the foregoing first process.

A10: Missing of image content

In the procedure of executing the first process, if the image content is missing, the operating system of the host computer enters an image unloaded state.

State 11: The first process is terminated.

After the host computer finishes execution of the first process, the host computer terminates the first process.

A11: Normal termination

State 12: Termination.

The host computer terminates running of the first target program.

A12: Abnormal termination 1

If the host computer does not successfully load the image, the host computer terminates the first process.

A13: Abnormal termination 2

If the host computer does not successfully determine the redirection interface, the host computer terminates the first process.

A14: Abnormal termination 3

If the first target program is not a target program that has registered with the operating system of the host computer, that is, the host computer does not successfully identify the first target program, the host computer terminates the first process.

A15: Termination

The host computer terminates running of the first target program.

As shown in Table 1, the ABI compatible interface 2 is corresponding to a complete compatibility procedure of the compatible state machine 20, that is, the ABI compatible interface 2 is corresponding to the compatibility method provided in this embodiment of the present invention.

TABLE 1

| | |
|---|---|
| A1 | Identification of the |
| | first target program |
| A2 | Creation of the first |
| | process |
| A3 | Image preprocessing |
| A4 | Image loading |
| A5 | Image reconstruction |
| A6 | Execution |
| A7 | Detection of the |
| | redirection interface |
| A8 | Determining of the |
| | redirection interface |
| A9 | Resumption of |
| | execution |
| A10 | Missing of the image |
| | content |
| A11 | Normal termination |
| A12 | Abnormal termination 1 |
| A13 | Abnormal termination 2 |
| A14 | Abnormal termination 3 |
| A15 | Termination |

The ABI compatible interface 2 shown in Table 1 is equivalent to provide a structure. Each member of the structure is a corresponding function. Each third-party operating system that needs to be compatible with the operating system of the host computer, needs to implement a corresponding structure and register the structure with the ABI compatibility component register queue 21. In the compatibility procedure, the compatible state machine 20 implements the various compatibility procedures by executing a function that is provided by the ABI compatibility component provided by the third-party operating system, so as to further support running of the first target program in the operating system of the host computer, that is, support and implement compatibility of the first target program in the operating system of the host computer.

Further, to enable the first target program in the third-party operating system to implement the compatibility in the operating system of the host computer, registration of the ABI compatibility component of the third-party operating system first needs to be completed.

A registration procedure of the ABI compatibility component is as follows:

(1) The operating system of the host computer provides a segment of space for the ABI compatible interface, so as to store each ABI compatibility component.

(2) The operating system of the host computer provides a registration functional module, so as to support registration of the corresponding ABI compatibility component for the third-party operating system.

(3) The registration functional module adds information of the ABI compatibility component of the third-party operating system into an ABI compatibility component register queue, so as to complete a registration of the ABI compatibility component of the third-party operating system in the operating system of the host computer.

It should be noted that, to ensure that the first target program runs normally in the operating system of the host computer, the operating system of the host computer needs to provide a compatible API (Application Programming Interface, application programming interface), compatible dynamic link library, and compatible processing flow for the first target program. Therefore, in a procedure in which the operating system of the host computer implements compatibility of the ABI compatible interface with the first target program, a necessary file, such as the dynamic link library, corresponding to the third-party operating system, first needs to be imported into the operating system of the host computer. In addition, the operating system of the host computer performs the registration of the ABI compatibility component of the third-party operating system.

Exemplarily, the following describes an implementation procedure of the compatibility method provided in this embodiment of the present invention by using cross-version compatibility of Linux operating system and compatibility of the third-party operating system with the ABI of a Linux operating system as examples.

Cross-Version Compatibility of the Linux Operating System:

A main reason why binary programs are not compatible among different versions of the Linux operating system is that a higher version Linux operating system modifies an API and a data structure of the Linux operating system for some reasons, thus, a first target program in an original lower version Linux operating system cannot directly run in the higher version Linux operating system. Table 2 shows an ABI compatible interface that is required when cross-version compatibility of the Linux operating system is implemented by using the compatibility method provided in this embodiment of the present invention.

Executable files in the Linux operating system are all in an executable and linking format (Executable and Linking Format, executable and linking format); therefore, an ABI compatible interface by using which the lower version Linux operating system performs compatibility with the higher version Linux operating system can be greatly simplified, that is, many operations in the ABI compatible interface may be empty, such as executable file identification and executable file loading. For the cross-version compatibility of the Linux operating system, only A9, that is, an operation of the redirection interface in the corresponding ABI compatible interface, needs to be modified. The reason why the lower version Linux operating system is not compatible with the higher version Linux operating system is that the API of the Linux operating system is changed. Therefore, simply by providing an API corresponding to the original lower version Linux operating system for the higher version Linux operating system, and redirecting a call of the first target program running in the higher version Linux operating system to the API of the original lower version Linux operating system in a dynamic link procedure, the first target program of the lower version Linux operating system can directly run in the higher version Linux operating system, that is, the higher version Linux operating system can be compatible with the lower version Linux operating system.

TABLE 2

| | |
|---|---|
| A1 | Empty |
| A2 | Fork function |
| A3 | Family of exec functions |
| A4 | Function loading |
| A5 | Empty |
| A6 | Empty |
| A7 | dlsym function start |
| A8 | dlsym function |
| A9 | Empty |
| A10 | Missing of image content |
| A11 | Normal termination |
| A12 | Abnormal termination 1 |
| A13 | Abnormal termination 2 |
| A14 | Empty |
| A15 | Empty |

Compatibility of Another Operating System with the ABI of the Linux Operating System:

A common practice to implement compatibility of the ABI of the Linux operating system in the other operating system is to implement, in the other operating system, an API that is compatible with the Linux operating system. In this case, the corresponding ABI compatible interface is shown in Table 1.

The procedure of implementing the compatibility of the ABI of the Linux operating system in the other operating system (for a better description, the other system is referred to as an operating system of a host computer hereinafter) includes the following:

(1) The host computer checks whether a file format ELF of a first target program is a file format that has been registered in the operating system of the host computer.

It can be understood that the first target program in step (1) is a target program in the Linux operating system.

(2) If the file format ELF of the first target program is a file format that has been registered in the operating system of the host computer, the host computer creates a first process for the first target program in the operating system of the host computer.

(3) The host computer remaps the first target program and generates a remapping table that indicates a mapping relationship between a first target program and a target program in the operating system of the host computer.

It should be noted that, if a file format of the target program in the operating system of the host computer is a class ELF, that is, the operating system of the host computer is an executable environment of the class ELF, the foregoing step (3) can be omitted.

(4) The host computer loads, according to the foregoing generated remapping table, into a memory of the host computer corresponding to the first process, and also relocates the first target program, so as to generate an image of the remapped first target program.

(5) The host computer reconstructs the foregoing image.

It should be noted that if an operation of sharing a segment of program code is performed on the foregoing image and another image, an image sharing reconstruction operation needs to be performed on the foregoing image; if binary translation needs to be performed on the foregoing image, in the procedure of performing the binary translation, an binary translation reconstruction operation needs to be performed on the foregoing image, so as to complete the reconstruction of the foregoing image.

Particularly, the foregoing step (5) can be omitted, if a format of the target program in the operating system of the host computer is compatible with a format of the first target program in the Linux operating system, an instruction system of the operating system of the host computer is the same as that of the Linux operating system, image sharing does not exist between the foregoing image and the another image, and the binary translation does not need to be performed on the foregoing image. On the contrary, the foregoing step (5) cannot be omitted, if the image sharing exists between the foregoing image and the other image, or the binary translation needs to be performed on the foregoing image.

(6) The host computer performs a redirection interface operation on the reconstructed image, so as to execute the first process.

In this step, the host computer needs to map a function call of the first target program in the Linux operating system to an API that is corresponding to the Linux operating system and is implemented in the operating system of the host computer, so that the first process can be successfully executed.

At this point, step (1) to step (6) complete the procedure in which the other operating system implements compatibility with the ABI of the Linux operating system.

The ABI compatible interface that runs in the compatibility device and is provided in this embodiment of the present invention, is configured to implement compatibility with an existing process-level ABI compatibility technology, and facilitate further extension of ABI of different operating systems. By using this ABI compatible interface, the operating system of the host computer can conveniently extend an execution environment of the ABI of a third-party operating system, and can implement compatibility with an existing target program to the most extent while reducing modification of the operating system of the host computer.

Further, the ABI compatibility component register queue provided in the embodiment of the present invention, is configured to register the corresponding ABI compatibility component of the third-party operating system in the operating system of the host computer. By using this ABI compatibility component register queue, the third-party operating system can implement compatibility of the target program of the third-party operating system in the operating system of the host computer provided that the third-party operating system implements an ABI compatibility component corresponding to the third-party operating system.

It can be clearly understood by a person skilled in the art that, for the purpose of convenient and brief description, the division of the foregoing functional modules described is merely an example. In an actual application, the foregoing functions can be accomplished by different functional modules according to a requirement, that is, the inner structure of the apparatus is divided into different functional modules to accomplish all or some of the functions described above. For a detailed working process of the foregoing system, apparatus, and unit, reference may be made to the corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the module or unit division is merely a logical function division and may be other divisions in actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, that is, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The computer software product is stored in a storage medium and includes several instructions for instructing a computer device (which may be a personal computer, a server, a network device, or the like) or a processor (processor) to perform all or a part of the steps of the methods described in the embodiments of the present invention. The storage medium includes: any medium that can store program codes, such as a USB flash disk, a removable hard disk, a read-only memory (Read-Only Memory, ROM), a random access memory (Random Access Memory, RAM), a magnetic disk, or an optical disk.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A compatibility method, comprising:
if a first target program is a locally registered target program, creating a first process for the first target program;
remapping the first target program;
generating a remapping table, wherein the remapping table indicates a correspondence between the first target program and the remapped first target program;
loading, according to the remapping table, the remapped first target program into a local memory corresponding to the first process, so as to generate an image of the remapped first target program;
reconstructing the image; and
determining a redirection interface of the reconstructed image, so as to execute the first process.

2. The compatibility method according to claim 1, wherein remapping the first target program comprises:
performing segment reassembly and/or offset calculation on the first target program.

3. The compatibility method according to claim 1, wherein loading, according to the remapping table, the remapped first target program into a local memory corresponding to the first process, so as to generate an image of the remapped first target program comprises:
acquiring a symbol table and a relocation table that are comprised in the first target program; and
loading the remapped first target program into the local memory according to the remapping table, and relocating the remapped first target program according to the symbol table and the relocation table, so as to generate the image.

4. The compatibility method according to claim 1, wherein reconstructing the image comprises:
performing image sharing reconstruction and/or binary translation reconstruction on the image.

5. The compatibility method according to claim 1, wherein determining a redirection interface of the reconstructed image comprises:
determining a redirection target of the reconstructed image, wherein the redirection target is a local interface corresponding to the reconstructed image; and
executing the redirection target, so as to determine the redirection interface of the reconstructed image.

6. The compatibility method according to claim 1, wherein in the procedure of executing the first process, if the image is missing, the remapped first target program is reloaded into the local memory according to the remapping table, so as to generate the image.

7. A compatibility device, comprising:
memory; and
a processor configured to:
if a first target program is a locally registered target program, create a first process for the first target program and store the first process in the memory,
remap the first target program, generate a remapping table, and store the remapping table in the memory, where the remapping table indicates a correspondence between the first target program and the remapped first target program,
load, according to the remapping table, the remapped first target program into a local memory corresponding to the first process in the memory, so as to generate an image of the remapped first target program,
reconstruct the image, and
determine a redirection interface of the reconstructed image, so as to execute the first process.

8. The compatibility device according to claim 7, wherein the processor is configured to perform segment reassembly and/or offset calculation on the first target program.

9. The compatibility device according to claim 7, wherein the processor is configured to:
acquire a symbol table and a relocation table that are included in the first target program;
load, according to the remapping table, the remapped first target program into the local memory corresponding to the first process in the memory; and
relocate the remapped first target program according to the symbol table and the relocation table, so as to generate the image.

10. The compatibility device according to claim 7, wherein the processor is configured to perform image sharing reconstruction and/or binary translation reconstruction on the image.

11. The compatibility device according to claim 7, wherein the processor is configured to determine a redirection target of the reconstructed image in the memory and execute the redirection target, so as to determine the redirection interface of the reconstructed image, where the redirection target is a local interface corresponding to the reconstructed image.

12. The compatibility device according to claim 7, wherein the processor is configured to:
in the procedure of executing the first process, if the image in the memory is missing, reload, according to the remapping table the remapped first target program into the local memory corresponding to the first process in the memory, so as to generate the image.
